(19) United States
(12) Patent Application Publication
(10) Pub. No.: US 2012/0313754 A1
(43) Pub. Date: Dec. 13, 2012

(54) BIOMETRIC SMART CARD READER

(75) Inventor: John Kenneth Bona, York, PA (US)

(73) Assignee: X-Card Holdings, LLC, Frazer, PA (US)

(21) Appl. No.: 13/495,567

(22) Filed: Jun. 13, 2012

Related U.S. Application Data
(60) Provisional application No. 61/496,132, filed on Jun. 13, 2011.

(51) Int. Cl. G05B 19/00

(52) U.S. Cl. 340/5.82

(57) ABSTRACT

A system and method for verifying the identity of an individual. The method may include for a smart card interfaced to a biometric interface device, determining if a match-on-card application exists on the smart card as a function of information contained on the card and capturing a biometric of an individual if a match-on-card application exists on the smart card using the biometric interface device. The captured biometric is then compared with a stored biometric. If the captured biometric matches with the stored biometric then a host application may be notified that the individual has been verified to access the data. Any one or several of these steps are performed without the use of a host application.

### CROSS REFERENCE TO RELATED APPLICATIONS

The present application is co-pending with and claims the priority benefit of the provisional application entitled “Biometric Smart Card Interface,” Application Ser. No. 61/496,132, filed on Jun. 13, 2011, the entirety of which is incorporated herein by reference.

### BACKGROUND

Enterprises and governments are increasingly relying on smart cards to provide identity authentication of individuals, information, devices, and/or assets. Smart cards may house, and in some cases, process security information for securely validating the identity of individuals, financial accounts, assets, etc.

Certain governments are also issuing and considering smart cards for their citizens for identity validation purposes and for providing useful historical information about their citizens. Many states in the United States and many foreign governments now issue drivers' licenses in the form of smart cards, which include a variety of information about a respective driver, such as blood type, medical conditions, prior driving record, photograph of the driver, physical characteristics of the driver, etc. Smart cards are also used to conduct business transactions and securely activate other devices or assets, such as accessing bank accounts, activating a lock to a safety deposit box, and the like.

Most smart cards today require some form of activation and authentication to access confidential information included on the smart cards or to access confidential information in another location gained by use of the smart card. Authentication is generally the process by which an entity, such as a financial institution or other type of institution, identifies and verifies itself to users and vice-versa. Authentication may include the use of physical objects, such as cards and/or keys, shared secrets, such as personal identification numbers (PINs) and/or passwords, and/or biometric technologies, such as voice prints, photos, signatures and/or fingerprints. Biometric tasks may include, for example, an identification task and a verification task. The verification task may determine whether or not the individual claiming an identity is the individual whose identity is being claimed. The identification task may determine whether the biometric characteristic, such as a fingerprint or other biometric, matches that of someone already enrolled in the system.

Conventionally, biometric systems have a common methodology, regardless of their modality, such as fingerprint, face, retina, voice, or the like. A person may enroll by donating some number of samples of the respective biometric. From these samples, the biometric system may create a model of the particular individual's patterns, which is referred to as a template. When the person attempts to access the system, the application collects new data. In a verification application, the individual may claim an identity, and the application retrieves the individual's model from a database and compares the new signal to the retrieved model. The result of this comparison is generally termed a match score indicating how well the new signal matches the template. The application then compares the match score obtained with a pre-defined threshold and decides whether to allow or deny access to the individual or, for example, to ask the individual for more data.

Various authentication parameters may be employed by security systems to verify a valid cardholder and to grant the cardholder access to a secured resource. Information parameters, such as PINs, may be read and processed by a card reader according to a system verification algorithm. However, information can be compromised, so that many authentication systems also require person-unique biometric parameters, such as fingerprints, retinal images, and the like. In such authentication systems, cardholder bio-specimens are conventionally stored in a system or host computer. Conventionally, during authentication the host computer obtains the information parameters, for example, from the card, and the biometric parameters from the person and matches both to the system-stored values. For a fingerprint, for example, there may be fourteen points and interpoint distances that the biometric reader compares and, depending on the match score, grants or denies access.

While various smart card interface devices and terminals are available today that can be used to support smart card, biometric, PIN entry, and/or challenge and response methods for multi-factor authentication, the host-based software controls the entire process for each method of authentication. For example, PC/SC Workgroup specifications Parts 1 through 10 the entirety of each are incorporated herein by reference, have been defined to support personal computer or host-based software in controlling the interactions with Smart Cards (ICCs) and Smart Card readers (IFDs). These PC/SC specifications provide for interoperability but do not relieve the host-based system from controlling the entire process of interaction with smart cards and provision of key security functions.

Thus, it is desirable to provide key security functions such as biometric authentication and PIN Code entry internally (i.e., on the device) while still retaining PC/SC compliance for interoperability.

### SUMMARY

Accordingly, there is a need for a system and method for verifying the identity of an individual. The method may include for a smart card interfaced to a biometric interface device, determining if a match-on-card application exists on the smart card as a function of information contained on the card and capturing a biometric of an individual if a match-on-card application exists on the smart card using the biometric interface device. The captured biometric is then compared with a stored biometric. If the captured biometric matches with the stored biometric then a host application may be notified that the individual has been verified to access the data. Any one or several of these steps are performed without the use of a host application.

In another embodiment of the present subject matter a method is provided for authenticating a user of a smart card. The method may include capturing a biometric of the user using a biometric interface device and creating a template file from the captured biometric. The created template file may then be compared with stored template information. If the created template file matches with the stored template information then a host application will be notified of the existence of a verification. Any one over several of these steps are performed without the use of a host application.

In yet another embodiment of the present subject matter a method for verifying an identity of a user of a smart card is provided. The method may include capturing a biometric of the user and verifying the identity of the user as a function of a comparison of the captured biometric to a stored template of a corresponding biometric. These steps may be performed without the use of a host application.

A further embodiment of the present subject matter provides a smart card interface apparatus having an electronic enclosure, a display on the electronics enclosure, and a biometric device for capturing a biometric of a user of a smart card. The apparatus further includes circuitry contained in the enclosure and having stored thereon one or more programs for processing a captured biometric of the user, for creating a template file from the captured biometric, for determining if a match-on-card application exists on the smart card, for comparing the created template file with stored template information, and for notifying a host application of the existence of a verified biometric if the created template file compares to the stored template information within a predetermined threshold. At least one of the one or more programs function without the use of a host application.

These and other embodiments of the present subject matter will be readily apparent to one skilled in the art to which the disclosure pertains from a perusal or the claims, the appended drawings, and the following detailed description.

### BRIEF DESCRIPTION OF THE DRAWINGS

FIG. 1 is a top plan view of a biometric smart card interface device according to one embodiment of the present subject matter.

FIG. 2 is an exploded perspective view of the biometric smart card interface device of FIG. 1.

FIG. 3 is a depiction of the connection of a biometric smart card interface device with a host computer system.

FIG. 4 is an illustration of an authentication flow chart according to one embodiment of the present subject matter.

FIG. 5 is an illustration of a general PC/SC specification architecture.

FIGS. 6A-6D are illustrations of biometric smart card interface devices according to embodiments of the present subject matter.

FIG. 7 is a flow diagram of a biometric match-on-card process according to one embodiment of the present subject matter.

FIG. 8 is an algorithm according to one embodiment of the present subject matter.

FIG. 9 is another algorithm according to an embodiment of the present subject matter.

FIG. 10 is a further algorithm according to an embodiment of the present subject matter.

### DETAILED DESCRIPTION

With reference to the figures, where like elements have been given like numerical designations to facilitate an understanding of the present subject matter, the various embodiments of a biometric smart card reader and method are described.

The phrase Smart Cards and acronym ICC are used interchangeably in this disclosure and such use should not limit the scope of the claims appended herewith. Further, the phrases and Smart Card readers/devices and acronym IFDs are used interchangeably in this disclosure and such use should not limit the scope of the claims appended herewith.

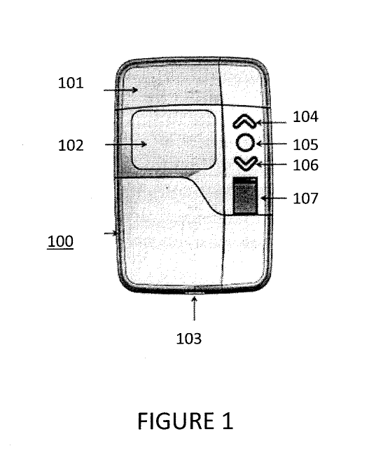

FIG. 1 is a top plan view of a biometric smart card interface device according to one embodiment of the present subject matter. With reference to FIG. 1, an exemplary biometric smart card interface device 100 may include an electronics enclosure having a top shell 101, a translucent cover over a display 102, and a back shell (not shown). Exemplary displays may include, but are not limited to, a liquid crystal display (LCD) and modules containing LCDs, an organic light-emitting diode (OLED) display, a thin film transistor (TFT) display, a touch screen display, or other display technologies. The device 100 may include any number of types of input/output (I/O) connections to a host computer system, such as a USB connection 103. Of course, a USB connection 103 is exemplary only and should not limit the scope of the claims appended herewith as any number of connections may be used including both wireless (e.g., Bluetooth, WiFi, cellular, etc.) and wireline connections. Representative host computer systems may include a Microsoft-, Apple-, Linux- or similarly based host. In one embodiment, the device 100 may include scrolling keys 104, 106 that allow a user to scroll through options presented on the display and selection keys 105 that allow a user to select a preferred choice. Of course, in embodiments of the present subject matter that contain a touch screen display, the device 100 may or may not include the scrolling and/or selection keys. The device 100 may in one embodiment include a biometric sensor 107 employed to capture an image of a fingerprint for enrollment or verification against a previously enrolled and stored biometric template. In further embodiments, other or multiple biometrics may be integrated into the device 100 for verification purposes. For example, voice recognition, facial or retinal imagery, and the like may be used as biometrics that can be substituted for, or used in addition to (if multiple biometrics are necessary), a fingerprint on the device 100. PIN entry may also be used. In another embodiment employing a touch screen display, it is envisioned that a portion or portions of the display are used as the biometric sensor to capture a fingerprint or other biometric.

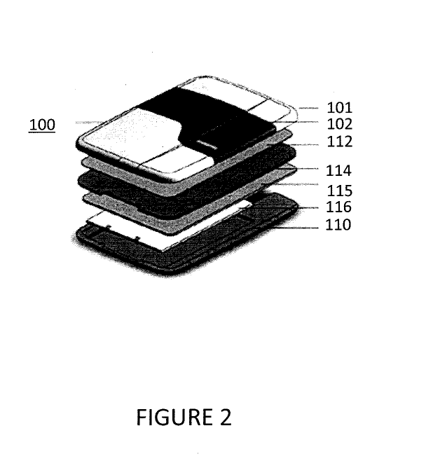

FIG. 2 is an exploded perspective view of the biometric smart card interface device of FIG. 1. With reference to FIG. 2, an exemplary biometric smart card interface device 100 may include an electronics enclosure having a top shell 101, a translucent cover 102 over a display, and a back shell 110. Internal components of the device 100 may be contained on a flexible printed circuit board assembly (PCBa) electronics layer 112 and supported on a PCB support layer 114. In another embodiment, the PCBa 112 and PCB support layers 114 may be combined onto a more rigid PCB material. The device 100 may or may not be portable and may include a battery 116 enclosed in the device, e.g., adjacent the PCB support layer 114 or another layer. Exemplary batteries may be, but are not limited to, lithium batteries, Li/SOCl₂ batteries, LiMnO₂ batteries, rechargeable batteries, non-rechargeable batteries, to name a few. In the depicted embodiment, a smart card 115 is illustrated adjacent the PCB support layer 114 and may be inserted into the device 100 via a slot. It is envisioned that embodiments of the device 100 may accept multiple smart cards 115 via one or more slots. Further, it is also envisioned that the device 100 may accept information from the smart card 115 using RF identification (RF ID) and associated protocols, infrared protocols, near field communication (NFC) protocols, and other proximity methods of communication, rather than requiring physical insertion of the card into the device 100.

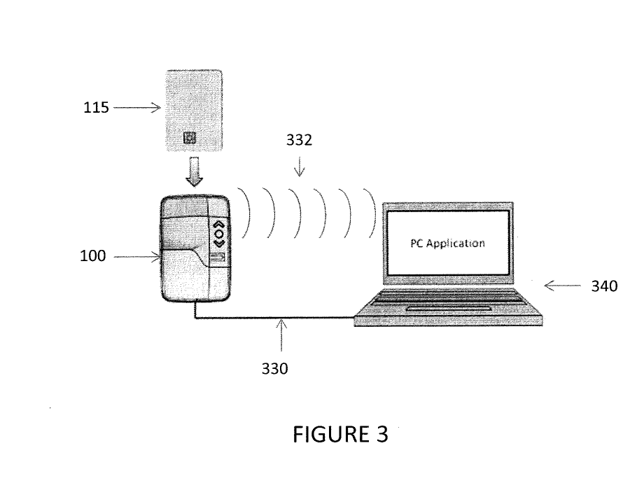

FIG. 3 is a depiction of a connection of a biometric smart card interface device with a host computer system. With reference to FIG. 3, an exemplary biometric smart card interface device 100 may be connected with a host computer system 340. Connection with the host computer system 340 may be made via a wireline connection 330 (e.g., USB connection or otherwise) and/or via a wireless connection 332 (WiFi, Bluetooth® or otherwise). In one embodiment, a smart card 115 may be inserted into the device 100 whereby smart card applications may be accessed by a PC Application running on the host computer system 340 with commands being sent to a smart card application and replies being received through the device 100 via applicable input/output (I/O) connections 330, 332. In this embodiment, the device 100 may be employed as a PC/SC compliant Interface Device (IFD) and thus a passive device in this mode of operation.

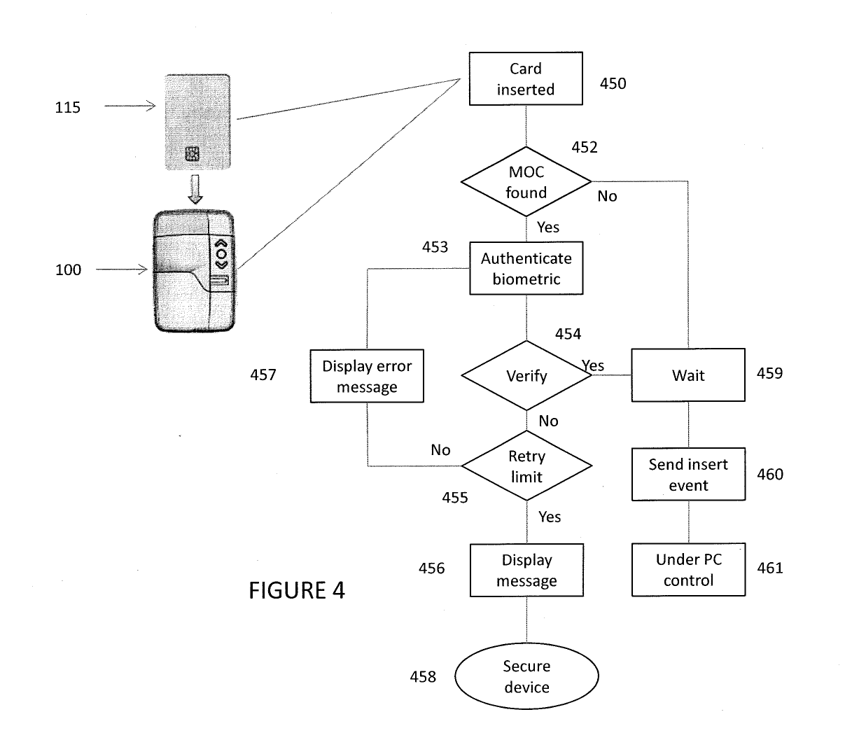

FIG. 4 is an illustration of an authentication flow chart according to one embodiment of the present subject matter. With reference to FIG. 4, exemplary functions provided by a biometric smart card interface device 100 are shown. Of course, these functions may support the PC/SC specifications. For example, in step 450 when a smart card 115 is inserted into a device 100, the device may apply power and a clock signal to the smart card and then place a reset line in a state requesting the smart card to provide an Answer To Reset (ATR) string to the device 100. The ATR string is defined in the ISO 7816-3 standard, the entirety of which is incorporated herein by reference.

Generally, an ATR is a series of signals sent out by a respective smart card when the card is powered up and reset for the first time (cold reset) or subsequently reset (warm reset). A cold reset may cause a primary ATR to be returned, a warm reset may cause a secondary ATR to be returned. ATR signals form bytes whereby the term signal is used to stress that an actual protocol to be used is undefined at this point within the communication. There are a number of low level handshaking steps that take place, during the power-up and ATR cycle, which will establish a protocol to use. The ATR itself is split into two blocks, a first block containing interface characters (bytes) and a second block containing historical characters (bytes). The final character in an ATR is an optional check character or TCK.

Interface characters are generally used to define operational parameters for a smart card. Information such as allowed protocols, voltage levels, class of smart card, and speed at which a clock frequency may be run may be conveyed as part of exemplary interface characters. The ISO 7816 specification provides timings and voltage levels that should be used when reading the ATR and thus interface characters are defined within this specification. Historical characters, however, are not defined by the ISO 7816 specification. Historical characters may include up to fifteen bytes of data which may be smart card or application specific. The number of historical characters may be defined within the interface characters to inform a respective IFD of how many bytes to expect. Interpretation of the historical characters, however, is left to an IFD application. Historical characters are often used to convey easily accessible information, such as, the amount of value currently held on a card. This information may thus enable a simple device (e.g., a Key Fob reader) to reset the card and display the value on the respective purse by only reading the historical characters. In embodiments of the present subject matter, the information contained in the ATR historical characters may be smart card specific and may contain a value informing a device 100 that the card contains a supported match-on-card (MOC) application (i.e., an on-card application that compares (matches) a captured biometric with a biometric reference pre-stored on the card). Of course, additional information may be contained in exemplary ATR historical characters including, but not limited to, information about the card manufacturer, the chip, masked ROM in the chip, the card life cycle state. Alternatively or additionally, one or more bytes of the historical characters may be used to indicate the MOC application installed on the smart card (ICC). The value may also inform the device 100 which application should be run on the smart card or may indicate that a EFDIR file should be referenced to find the proper MOC application to be run on the smart card. A typical structure of an EFDIR file is defined in ISO 7816-4 and 7816-5, the entirety of each being incorporated herein by reference.

For example, in one embodiment the ATR string may be used to determine the type of smart card 115 inserted into the device 100. Activation and operation of a smart card is generally governed by ISO 7816 standards, the entirety of which are incorporated herein by reference. During step 452 the device 100 may determine if a support MOC application exists on the smart card 115. With receipt of the ATR string, the device has specific information about the capabilities of a card and how to send commands and receive replies from an operating system (OS) and/or smart card applications. This information may allow the device 100 to directly interact with the smart card 115 to determine if a supported MOC application exists.

Of course, the ATR string is exemplary only and is but one of several sources of information used in embodiments of the present subject matter to determine if a MOC application is resident on the smart card 115. For example, at least two other, non-limiting sources may be an ATR File and a directory (DIR) File.

An ATR File may include a default elementary file identifier (FID) of ‘0x2F01’ and may include a customized ATR string. In one embodiment, a ‘2F01’ file may include additional data for the ATR and may be an extension to the historical characters which are limited to 15 bytes. The content of this file, whose structure is not defined by the ISO/IEC standard, may be ASN.1-coded. The parameters in the ATR file or the historical characters may contain complex information relating to the smart card and the operating system used in the card. For example, the parameters may indicate which file selection and implicit selection function are supported by the smart card and provide information about the logical channel mechanism. These parameters may also hold additional information about the card issuer, the card and chip serial numbers, the ROM mask version, the chip and the operating system. The coding of the relevant data objects may be defined in the ISO/IEC 7816-4 and 7816-5 standards. According to ISO/IEC 7816-4, the historical characters may also contain the following three data fields: an obligatory category indicator, one or more optional data blocks in compact TLV format, and an optional status indicator. The compact TLV format may have a tag in the first nibble and the length of subsequent data in a second nibble. The category indicator may be transferred in T1 and may include information about the structure of the data in the ATR. The data following the category indicator may include information about the services supported by the smart card operating system and the operating system functions. The ATR File may contain any necessary data to permit a device 100 to know that a smart card contains a supported MOC application or any other key information that the device 100 would need to authenticate the card/card holder correctly. In another embodiment, the ATR File may include one 36 byte record and changes to the ATR historical bytes may come from information in the ATR File. Information in the ATR File may thus denote the presence of a MOC application, and the identified application may either be defined or assumed by the device 100 based upon the information returned.

A DIR File may be an elementary file defined in the ISO/IEC 7816-5 standard with a file identifier of ‘0x2F00’ and found in the root directory of the smart card file system. Generally, a ‘2F00’ structure is a linear fixed structure having n bytes. Table 1 below provides one exemplary, non-limiting ‘2F00’ structure.

TABLE 1

| Byte No. | Description | Example |
|---|---|---|
| 1 | ‘61’ (‘application tag’) | ‘61’ |
| 2 | length of the application template | ‘0F’ 15 bytes |
| | (3-127) | |
| 3 | ‘4F’ (AID Tag) | ‘4F’ |
| 4 | length of the AID (1-16) | ‘05’ 5 bytes |
| 5 − n | AID (application identifier) | ‘D2 76 00 00 60’ |
| n + 1 | ‘50’ (‘application tag’) | ‘50’ |
| n + 2 | length of the application label (m) | ‘05’ 5 bytes |
| n + 3 − m | application level in ASCII (1-16) | ‘52 61 6E 6B 6C’ |

The contents of this linear file may, in one embodiment, be read to determine if any of the AIDs denote a supported MOC application. If a supported MOC application is found, the device 100 may begin a biometric capture and compare processes. Objects (or records) may include an AID, an optional path to the directory and/or application files, and/or control commands for each application on the smart card. Thus, entries in the DIR file may be read to determine if a supported MOC application exists on the smart card and where and how to initiate the application.

Any of these options for determining the presence of a MOC application may be employed in step 452 by an exemplary device 100 to set a value indicator for the decision to be made during this step. For example, if the value indicates that no MOC application exists (or is recognized as such) for supporting biometric authentication, then it may be determined in step 459 whether the device 100 is presently attached to a host computer system. If the I/O connection is active, then in step 460 an insert event and/or ATR string may be provided to the host computer system through the supported I/O connection and, in step 461 the device 100 may then be under the control of a host application. Host applications may then send commands and receive replies to smart card applications stored and run on the smart card 115 inserted into the device 100.

If, in step 452, the value indicator denotes a MOC application for supporting biometric authentication then, in step 453 applicable processes may be performed that are required for biometric authentication. These processes would be not be under the control of a host application. For example, in step 453 a biometric sample may be obtained by a device 100 and compared by the device 100 or smart card 115 against a previously obtained biometric sample stored on the smart card 115. If the two samples are likely matches (e.g., using a predefined/stored threshold or template and denoting a successful match) then the biometric may be considered as verified. Of course, different and/or multiple types of biometrics may be obtained with devices 100 according to embodiments of the present subject matter. For example, a camera may be used to capture a facial or retinal image, a microphone may be used for voice recognition and/or a fingerprint sensor may be used to capture a fingerprint. The embodiments described herein may also include a silicon area sensor for capturing a fingerprint image from a stationary finger. Silicon swipe sensors and optical sensors may also be employed for the same purpose. Exemplary fingerprint sensors include, but are not limited to, SmartFinger film fingerprint sensors, TouchChip fingerprint sensors, and other known silicon or polymer-based fingerprint or swipe sensors. Once a biometric, in this case a fingerprint image, has been captured by the fingerprint sensor a template may be generated with image or minutiae data. The device 100 may then generate a “Verify” statement send this command and template data to the MOC application stored and run on the Smart Card ICC. The MOC application would then compare the template provided with a previously enrolled template stored on the smart card 115 and determine if the two templates match to an extent it would consider a positive or likely match.

In step 454, if the biometric was determined to be “Verified” (e.g., successfully matched against the previously stored biometric template), then it may be determined in step 459 whether the device 100 is presently attached to a host computer system. If the I/O connection is active, then in step 460 an insert event and/or ATR string may be provided to the host computer system through the supported I/O connection and, in step 461 the device 100 may then be under the control of a host application.

If the biometric was determined not to be “Verified” in step 454, then it may be determined if a retry limit has been reached. Generally, a retry limit corresponds to a counter which identifies the number of times authentication has been attempted. If the retry limit has been reached, a message may or may not be displayed in step 456 regarding that the limit has been reached. Further, if the retry limit has been reached, power to the device 100 may be secured and/or the device 100 otherwise turned off in step 458. In one embodiment, the smart card 115 may be returned to the user if inserted into a respective slot of the device 100 and then the device 100 turned off. If the retry limit has not been reached, then the user may be prompted to provide another biometric sample in step 457. Of course, any one or several of the captured biometrics during this iterative process may be different and multiple biometrics may be employed during any one or several iterations.

While biometric authentication through a MOC application has been discussed above, the same or similar process may be employed to perform PIN Code verification or both biometric and PIN code verification. Further, the ATR string, ATR File, and DIR file may also define more than one authentication process that needs to be completed before the smart card is available for receiving commands from an host application.

Conventionally, certain steps described above and illustrated in FIG. 4 are provided by a host application and difficult to develop and support. Conventionally, the host application receives the insert event from the IFD and must verify that the proper card has been inserted. The host application must also verify if the MOC application is present, and the host application must send commands through an IFD Service Provider to communicate with the IFD reader to start a biometric capture. Additionally, the host application will continue with a template creation process, the host application will submit this template to the MOC application, and then the host application will read the result to determine if the user has been properly authenticated. Thus, conventionally there may be multiple commands and a significant amount of host-side processing to support biometric authentication. Embodiments of the present subject matter, however, may provide such functionality without any interaction by the host computer system (i.e., without any interaction by a host application). Thus, the device 100 and the smart card 115 inserted into the device 100 are not visible to the host application until the user has been authenticated. Further, if the developers of a host application are desirous to add a layer of security comprised of a biometric or a multi-factor scheme, the device 100 may perform all the necessary activities internally and may become a plug and play security layer for the host application in one embodiment.

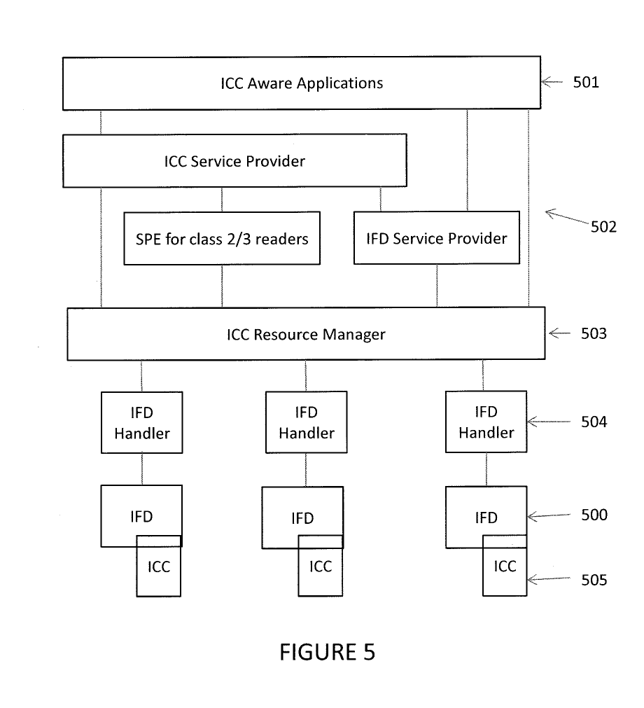

FIG. 5 is an illustration of a general PC/SC specification architecture. With reference to FIG. 5, ICC aware applications 501 represent user based applications that make use of ICCs and IFDs to provide some specific functionality. One example may be a multi-factor authentication for logical access control security. Service providers 502 are generally responsible for encapsulating functionality exposed by a specific ICC or IFD and for making these accessible through high-level programming interfaces. Applicable interfaces may be enhanced and extended to meet the needs of specific application domains. Connected to the ICC aware applications 501 and service providers 502 is an ICC resource manager 503. The ICC resource manager 503 is generally responsible for managing ICC-relevant resources within a system and for supporting controlled access to IFDs 500 and, through them, individual ICCs 505. The ICC resource manager 503 may be a system-level component of the architecture and may be provided by an OS vendor.

Connected to the ICC resource manager 503 are IFD handlers 504 which encompass the PC software necessary to map native capabilities of an IFD 500 to an IFD handler interface. The IFD handler 504 is typically low-level software within the PC that supports specific I/O channels used to connect the IFD 500 to the PC and provides access to specific functionality of the IFD 500. This is the layer of the interoperability specification primarily responsible for facilitating the interoperability between different IFDs 500. The IFD 500 corresponds to an exemplary device described herein and may be the interface device through which ICCs 505 communicate with a PC. The IFD 500 may provide DC power to the respective microprocessor chip, may provide a clock signal used to step a program counter of the microprocessor, and may provide an I/O connection (wireless or wireline) though which digital information is passed between the IFD 500 and ICC 505. Exemplary IFDs 500 may have one or more slots to read ICCs 505 and may also support extended capabilities such as display or PIN pad, to name a few. In one embodiment, an IFD 500 may support a card insertion notification event and/or a card removal notification event. Thus, when one of these events occurs, it may be the responsibility of the IFD Handler 504 to appropriately notify the ICC Resource Manager 503. In one embodiment of the present subject matter, the card insertion notification may be withheld until the respective biometric MOC has completed with a positive or “authenticated” result. Exemplary IFDs or devices 500 may thus be considered PC/SC compliant and provide unique features to support biometric, PIN code and/or challenge response authentication prior to placing itself under control of a host application (e.g., ICC Aware Applications 501). This capability may thus relieve the ICC Aware Application 501 from controlling the process of enrollment of biometric samples, template creation, and matching biometric template. Embodiments of the present subject matter may thus provide the ICC Aware Application 501 with a higher level of access control security without having to be involved in providing this capability.

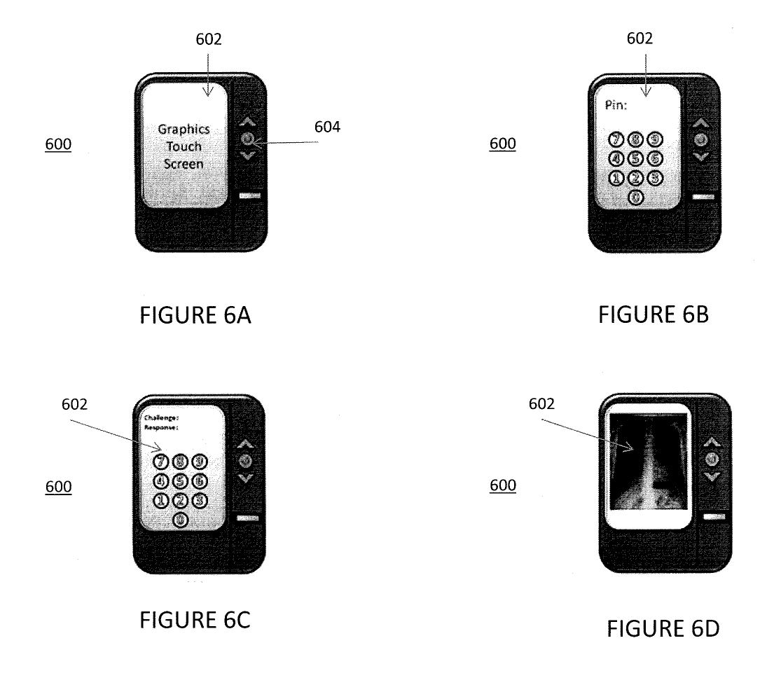

FIGS. 6A-6D are illustrations of biometric smart card interface devices according to embodiments of the present subject matter. With reference to FIG. 6A, an exemplary device 600 may include a graphics touch screen 602 and a silicon fingerprint swipe sensor 604. With reference to FIG. 6B, an exemplary device 600 may use a touch screen display 602 to display a PIN pad allowing entry of a value to be compared against a value stored on a smart card (not shown). In this embodiment, if the values match the I/O may be activated, and the device 600 may then be under control of a host application. With reference to FIG. 6C, an exemplary device 600 may provide another PIN pad solution for a challenge and response function using a graphics touch screen 602. With reference to FIG. 6D, an exemplary device 600 may allow data and/or files to be sent from a host application directly to secured storage on the device 600 or to display data or images using a graphics touch screen 602. Thus, in one embodiment an exemplary device 600 may be employed as a portable medical records repository or other portable data storage device where access to (upload of) this or other confidential information is secured by biometric or PIN code (or both) security. An authenticated user may then use the touch screen 602 or scroll and/or select keys to display images or other medical records stored on the device 600.

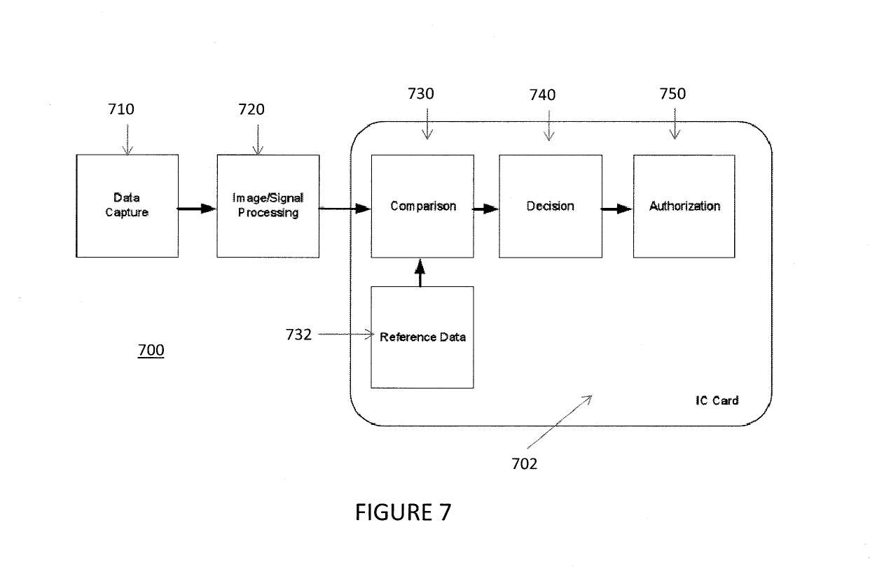

FIG. 7 is a flow diagram of an biometric match-on-card process according to one embodiment of the present subject matter. With reference to FIG. 7, an exemplary, non-limiting biometric MOC process may include at step 710 capturing a live image of a biometric, such as, but not limited to a fingerprint. At step 720, a template file may be created from the captured image. At step 730, this created template file may be compared with a template stored on the applicable smart card 702. The stored template 732 may be a biometric template file created during the biometric enrollment process for future comparison processes. At step 740, if the created template sufficiently compares to the reference data or stored template 732 within a predetermined threshold which determines how close the template must match to be considered a positive result, then a host application can be notified of the existence of the smart card at step 750 and the user authorized. Of course, this is only a non-limiting example of a MOC process as many other MOC processes may fall within the scope of the claims appended herewith.

For example, another MOC process may include enrolling or storing one or more biometrics for a cardholder whereby such information is stored on a smart card as a template. Any additional personal or confidential data may also be stored on the smart card. The cardholder's smart card may then be placed in a reader which will then prompt the person to present a previously enrolled biometric. At this time, an exemplary system may provide information about the person, depending upon the application, and the live biometric is read and analyzed. When compared, if the biometric from the person and the template on the card match, the identity of the cardholder has been verified. The system may then perform any requested actions such as uploading confidential data, etc. If the information does not match, the requested action may be rejected and the true cardholder's credentials protected from fraud or misuse.

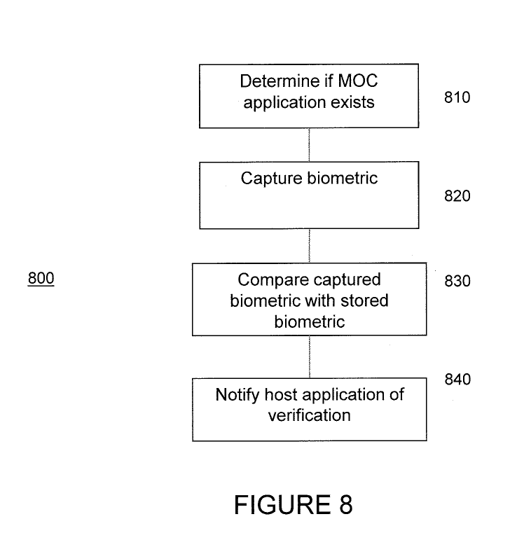

FIG. 8 is an algorithm according to one embodiment of the present subject matter. With reference to FIG. 8, a method 800 for verifying the identity of an individual may include, in step 810, for a smart card interfaced to a biometric interface device, determining if a match-on-card application exists on the smart card as a function of information contained on the card. This data may be data on the smart card, data on a host device and/or data at a host entity. As discussed above, the contained information on the smart card may be an ATR string, an ATR File, or a DIR File. Of course, the contained information on the smart card may also be any one or several of historical characters, interface characters, file selection capabilities supported by the smart card, selection functions supported by the smart card, card issuer, card serial number, chip serial number, read only memory mask version, operating system application identifier (AID), entries in a directory file, and combinations thereof. If a match-on-card application exists on the smart card using a biometric interface device, then a biometric of the user may be captured at step 820. Exemplary biometrics include, but are not limited to a fingerprint image, a facial image, a retinal image, voice recognition, PIN code, challenge and response techniques, signature capture or comparison, and combinations thereof. The captured biometric may then be compared with a stored biometric at step 830. If the captured biometric matches the stored biometric, then a host application may be notified that the individual has been verified at step 840. Of course, any one or more of steps 810-840 may be performed without the use of a host application.

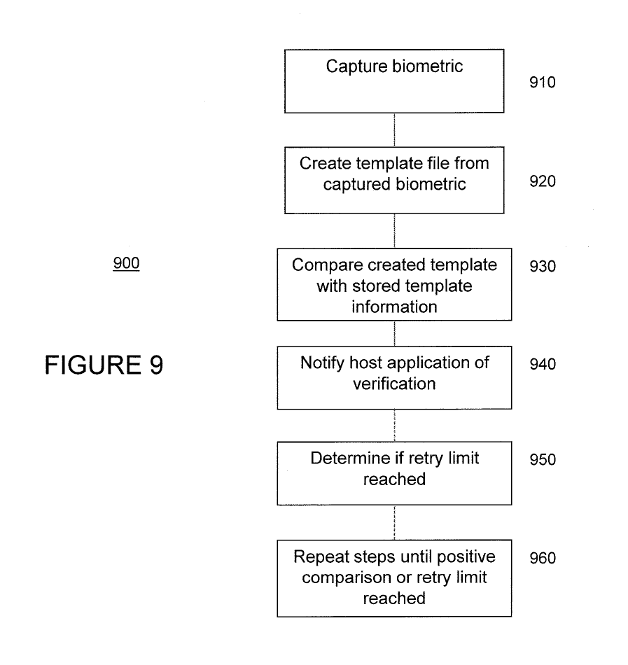

FIG. 9 is another algorithm according to an embodiment of the present subject matter. With reference to FIG. 9, a method 900 for authenticating a user of a smart card may include, in step 910, capturing a biometric of the user using a biometric interface device. In one embodiment, step 910 may include determining if a match-on-card application exists on the smart card as a function of information contained on the card. The contained information on the smart card may be an ATR string, an ATR File, or a DIR File. Of course, the contained information on the smart card may also be any one or several of historical characters, interface characters, file selection capabilities supported by the smart card, selection functions supported by the smart card, card issuer, card serial number, chip serial number, read only memory mask version, operating system application identifier (AID), entries in a directory file, and combinations thereof. As described above, the biometric capture may be performed using a handheld biometric device in one embodiment. Exemplary biometrics include, but are not limited to a fingerprint image, a facial image, a retinal image, voice recognition, PIN code, challenge and response techniques, signature capture or comparison, and combinations thereof.

In step 920, a template file may be created from the captured biometric, and the created template file may then be compared with stored template information at step 930. In one embodiment, the stored template information may have been created during a biometric enrollment process for use in subsequent comparison processes. In step 940, if the created template file matches the stored template information, then a host application may be notified of the existence of a verification. In another embodiment, step 940 may include authorizing the user to access information on the smart card, on a host device, at a host entity, or combinations thereof. Of course, any one or more of steps 910-940 may be performed without the use of a host application. In a further embodiment, if the created template file does not match the stored template information, then the method 900 may include at step 950 determining if a retry limit has been reached. In the event at step 960 that the retry limit has not been reached, then any or each of the preceding steps may be repeated until the created template file matches the stored template information (i.e., a positive comparison) or until the retry limit has been reached. If the retry limit has been reached, then the biometric interface device may be secured. Of course, any one or several of the captured biometrics during this process may be different and multiple biometrics may be employed during any one or several iterations. Further, any one or both of steps 950 and 960 may be performed without the use of a host application.

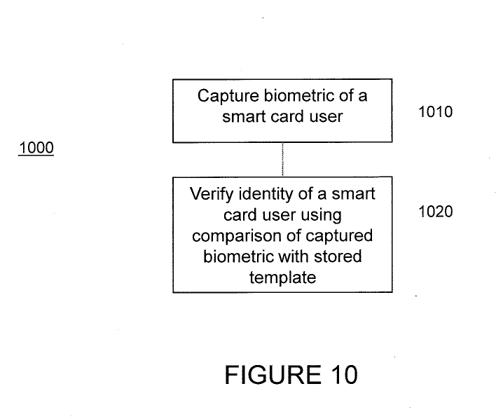

FIG. 10 is a further algorithm according to an embodiment of the present subject matter. With reference to FIG. 10, a method 1000 for verifying an identity of a user of a smart card may include at step 1010 capturing a biometric of the user and at step 1020 verifying the identity of the user as a function of a comparison of the captured biometric to a stored template of a corresponding biometric. Each of steps 1010 and 1020 may be performed without the use of a host application. In one embodiment, step 1010 may include determining if a match-on-card application exists on the smart card as a function of information contained on the card without the use of a host application. The contained information on the smart card may be an ATR string, an ATR File, or a DIR File. Of course, the contained information on the smart card may also be any one or several of historical characters, interface characters, file selection capabilities supported by the smart card, selection functions supported by the smart card, card issuer, card serial number, chip serial number, read only memory mask version, operating system application identifier (AID), entries in a directory file, and combinations thereof. In another embodiment, step 1010 may include if a match-on-card application is determined not to exist on the smart card then providing the host application with control of the device.

It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

Embodiments of the subject matter and the functional operations described in this specification can be implemented in digital electronic circuitry, or in software, firmware, or hardware, including the structures disclosed in this specification and their structural equivalents, or in combinations of one or more of them. Embodiments of the subject matter described in this specification can be implemented as one or more program products, i.e., one or more modules of program instructions encoded on a tangible program carrier for execution by, or to control the operation of, a data processing apparatus. The tangible program carrier can be a computer readable medium. The computer readable medium can be a machine-readable storage device, a machine-readable storage substrate, a memory device, or a combination of one or more of them.

The term “processor” encompasses all apparatus, devices, and machines for processing data, including by way of example a programmable processor, a computer, or multiple processors or computers. The processor can include, in addition to hardware, code that creates an execution environment for the program in question, e.g., code that constitutes processor firmware, a protocol stack, a database management system, an operating system, or a combination of one or more of them.

A program (also known as a computer program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code).

The processes and logic flows described in this specification can be performed by one or more programmable processors executing one or more programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of an exemplary program include, by way of example, both general and special purpose microprocessors, and any one or more processors of any kind of digital computer. Generally, a processor will receive instructions and data from a read only memory or a random access memory or both.

While this specification contains many specifics, these should not be construed as limitations on the scope of the claimed subject matter, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As shown by the various configurations and embodiments illustrated in FIGS. 1-10, a biometric smart card reader, system and method have been described.

While preferred embodiments of the present subject matter have been described, it is to be understood that the embodiments described are illustrative only and that the scope of the invention is to be defined solely by the appended claims when accorded a full range of equivalence, many variations and modifications naturally occurring to those of skill in the art from a perusal hereof.

I claim:

1. A method for verifying the identity of an individual, the method comprising the steps of:
(a) for a smart card interfaced to a biometric interface device, determining if a match-on-card application exists on the smart card as a function of information contained on the card;
(b) capturing a biometric of the user if a match-on-card application exists on the smart card using the biometric interface device;
(c) comparing the captured biometric with a stored biometric; and
(d) notifying a host application that the individual has been verified if the comparing step (c) indicates a match,
wherein one or more of steps (a)-(d) are performed without the use of a host application.

2. The method of claim 1 wherein after step (d) access is granted to data on the smart card, data on a host device, data at a host entity, or combinations thereof.

3. The method of claim 1 wherein the biometric is selected from the group consisting of a fingerprint image, a facial image, a retinal image, voice recognition, PIN code, challenge and response techniques, signature capture or comparison, and combinations thereof.

4. The method of claim 1 wherein the contained information on the smart card is selected from the group consisting of an Answer To Reset (ATR) string, an ATR File, and a Directory (DIR) File.

5. The method of claim 1 wherein the contained information on the smart card is selected from the group consisting of historical characters, interface characters, file selection capabilities supported by the smart card, selection functions supported by the smart card, card issuer, card serial number, chip serial number, read only memory mask version, operating system application identifier (AID), entries in a directory file, and combinations thereof.

6. A method for authenticating a user of a smart card comprising the steps of:
(a) capturing a biometric of the user using a biometric interface device;
(b) creating a template file from the captured biometric;
(c) comparing the created template file with stored template information; and
(d) notifying a host application of the existence of a verification if the comparing step (c) indicates a match,
wherein one or more of steps (a)-(d) are performed without the use of a host application.

7. The method of claim 6 wherein the step of capturing a biometric further comprises determining if a match-on-card application exists on the smart card as a function of information contained on the card.

8. The method of claim 7 wherein the contained information on the smart card is selected from the group consisting of an Answer To Reset (ATR) string, an ATR File, and a Directory (DIR) File.

9. The method of claim 7 wherein the contained information on the smart card is selected from the group consisting of historical characters, interface characters, file selection capabilities supported by the smart card, selection functions supported by the smart card, card issuer, card serial number, chip serial number, read only memory mask version, operating system application identifier (AID), entries in a directory file, and combinations thereof.

10. The method of claim 6 wherein the biometric is selected from the group consisting of a fingerprint image, a facial image, a retinal image, voice recognition, PIN code, challenge and response techniques, signature capture or comparison, and combinations thereof.

11. The method of claim 6 wherein the biometric capture is performed using a handheld biometric device.

12. The method of claim 6 wherein the stored template information is created during a biometric enrollment process for use in subsequent comparison processes.

13. The method of claim 6 wherein the step of notifying a host application further comprises authorizing the user to access information on the smart card, on a host device, at a host entity, or combinations thereof.

14. The method of claim 6 further comprising the steps of:
(e) if the created template file does not match the stored template information, then determining if a retry limit has been reached; and
(f) if the retry limit has not been reached, then repeating steps (a)-(f) until the created template file matches the stored template information or until the retry limit has been reached.

15. The method of claim 14 wherein subsequent captured biometrics are different.

16. The method of claim 14 wherein one or more of steps (e) and (f) are performed without the use of a host application.

17. The method of claim 14 further comprising the step of securing the biometric interface device if the retry limit has been reached.

18. In a method of verifying an identity of a user of a smart card comprising the steps of capturing a biometric of the user and verifying the identity of the user as a function of a comparison of the captured biometric to a stored template of a corresponding biometric, the improvement comprising performing the steps of capturing a biometric and verifying the identity of the user without the use of a host application.

19. The method of claim 18 wherein the step of capturing a biometric further comprises determining if a match-on-card application exists on the smart card as a function of information contained on the card without the use of a host application.

20. The method of claim 19 wherein the contained information on the smart card is selected from the group consisting of an Answer To Reset (ATR) string, an ATR File, and a Directory (DIR) File.

21. The method of claim 19 wherein the contained information on the smart card is selected from the group consisting of historical characters, interface characters, file selection capabilities supported by the smart card, selection functions supported by the smart card, card issuer, card serial number, chip serial number, read only memory mask version, operating system application identifier (AID), entries in a directory file, and combinations thereof.

22. The method of claim 19 wherein the step of capturing a biometric further comprises if a match-on-card application is determined not to exist on the smart card, then providing the host application with control of the device.

23. The method of claim 18 wherein the biometric is selected from the group consisting of a fingerprint image, a facial image, a retinal image, voice recognition, PIN code, challenge and response techniques, signature capture or comparison, and combinations thereof.

24. A smart card interface apparatus comprising:
an electronic enclosure;
a display on said electronics enclosure;
a biometric device for capturing a biometric of a user of a smart card; and
circuitry contained in said enclosure and having stored thereon one or more programs for processing a captured biometric of the user, for creating a template file from the captured biometric, for determining if a match-on-card application exists on the smart card, for comparing the created template file with stored template information, and for notifying a host application of the existence of a verified biometric if the created template file compares to the stored template information within a predetermined threshold, wherein at least one of the one or more programs function without the use of a host application.

25. The apparatus of claim 24 wherein the smart card interface apparatus is handheld.

26. The apparatus of claim 24 wherein the one or more programs determines if a match-on-card application exists on the smart card as a function of information contained on the card.

27. The apparatus of claim 26 wherein the contained information on the smart card is selected from the group consisting of an Answer To Reset (ATR) string, an ATR File, and a Directory (DIR) File.

28. The apparatus of claim 26 wherein the contained information on the smart card is selected from the group consisting of historical characters, interface characters, file selection capabilities supported by the smart card, selection functions supported by the smart card, card issuer, card serial number, chip serial number, read only memory mask version, operating system application identifier (AID), entries in a directory file, and combinations thereof.

29. The apparatus of claim 24 wherein the biometric is a fingerprint image.
